(19) United States
(12) Patent Application Publication
(10) Pub. No.: US 2006/0053292 A1
(43) Pub. Date: Mar. 9, 2006

(54) Watermarking of a variable bit-rate signal

(75) Inventor: Gerrit Cornelis Langelaar, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/532,934

(22) PCT Filed: Sep. 22, 2003
(86) PCT No.: PCT/IB03/04277

§ 371 Date: Apr. 27, 2005

(30) Foreign Application Priority Data
Oct. 30, 2002 (EP) 02079548.0

(51) Int. Cl. H04L 9/00

(52) U.S. Cl. 713/176

(57) ABSTRACT

Methods and apparatus for embedding a watermark in an information signal (MPin) are described. The watermark embedding process is controlled by at least one embedding parameter. The value of the embedding parameter is dependent upon the bit-rate of the information signal (MPin).

### FIELD OF THE INVENTION

The present invention relates to apparatus and methods for embedding and detecting watermarks in information signals, and in particular in information signals that can be transmitted at a variety of bit-rates.

### BACKGROUND OF THE INVENTION

Watermarking of information signals is a technique for the transmission of additional data along with the information signal. For instance, watermarking techniques can be used to embed copyright and copy control information into multimedia signals, such as audio, video or data signals.

The main requirement of a watermarking scheme is that it is not observable (i.e. in the case of an audio signal, it is inaudible; in the case of a video signal, it is not visible) whilst being robust to attacks to remove the watermark from the signal (e.g. removing the watermark will damage the signal). It will be appreciated that the robustness of the watermark will normally be a trade off against the quality of the signal in which the watermark is embedded. For instance, if a watermark is strongly embedded into an audio signal (and is thus difficult to remove) then it is likely that the quality of the audio signal will be reduced.

Information signals can be transmitted at a variety of bit-rates. Some signals, such as MPEG2 signals, encode the bit-rate in the bit-stream.

It is an object of the present invention to provide a watermark embedding scheme suitable for embedding the watermark in information signals that can be transmitted at different bit-rates.

It is an object of the present invention to provide a watermarking scheme that substantially addresses at least one of the problems of the prior art, whether referred to herein or otherwise.

### STATEMENTS OF THE INVENTION

In a first aspect, the present invention provides a method of embedding a watermark in an information signal, wherein the watermark embedding process is controlled by at least one embedding parameter, the value of the embedding parameter being dependent upon the bit-rate of the information signal.

By selecting the embedding parameters of the watermark in dependence upon the bit-rate of the signal, an optimal performance trade-off can be made between the watermark being robust whilst not being significantly observable. Experimentation has shown that if a single set of embedding parameters is utilised irrespective of signal bit-rate, then the watermark is more likely to be observable at low bit-rates, whilst being relatively un-robust at high bit-rates.

In another aspect, the present invention provides an apparatus arranged to embed a watermark in an information signal, the apparatus comprising an embedding means arranged to embed a watermark in the information signal utilising an embedding process controlled by at least one embedding parameter, the value of the embedding parameter being dependent upon the bit-rate of the information signal.

In a further aspect, the present invention provides a watermarked information signal, wherein the original information signal has been watermarked by a watermarking process controlled by at least one embedding parameter, the value of the embedding parameter having been dependent upon the bit-rate of the information signal.

In another aspect, the present invention provides a record carrier comprising a watermarked information signal as described above.

In a further aspect, the present invention provides a method of detecting a watermark in an information signal, the method comprising analysing an information signal that may potentially comprise a watermark, so as to detect the watermark, the analysing process being dependent upon the bit-rate of the information signal.

In another aspect, the present invention provides an apparatus for the detection of a watermark in an information signal, the apparatus comprising analysing means arranged to analyse an information signal that may potentially comprise a watermark, so as to detect the watermark, the operation of the analysing means being dependent upon the bit-rate of the information signal.

In a further aspect, the present invention provides a computer program arranged to perform at least one of the methods as described above.

In another aspect, the present invention provides a record carrier comprising a computer program as described above.

In a further aspect, the present invention provides a method of making available for downloading a computer program as described above

Other aspects of the invention will be apparent from the dependent claims.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a schematic diagram of an apparatus suitable for embedding a watermark in accordance with a preferred embodiment of the present invention;

FIGS. 2A-2G show diagrams illustrating the operation of the apparatus shown in FIG. 1; and

FIG. 3 shows schematically a watermark detecting apparatus in accordance with an embodiment of the present invention.

### DETAILED DESCRIPTION OF PREFERRED EMBODIMENTS

The present invention selects different watermark embedding parameter settings (including parameters that may control the type of watermarking methods utilised) in dependence on the bit-rate of the information signal.

Experimentation has shown that providing an optimal trade off between robustness and visibility for high bit-rate signals (e.g. high definition MPEG signals) is possible for certain parameter sets. However, if the same algorithm is utilised with the same parameters for low bit-rate signals, the visual quality of the signal is poor. Consequently, the inventors have realised that rather than providing a generic parameter setting for watermarks, system performance is much improved by utilising different watermark embedding parameter settings and/or different watermarking methods depending on the bit-rate of the information signal.

The present invention is particularly appropriate for use with compressed multimedia signals, in which the bit-rate is encoded in the bit-stream or can be determined from the bit-stream. This facilitates detection of the information stream bit-rate. For instance, in MPEG the bit-rate can be determined from the number of frames per second, in combination with counting the number of bytes between any two successive start conditions indicating a picture start.

A preferred embodiment of the present invention will now be described with reference to a known watermarling scheme. A single embedding algorithm is utilised. The bit-rate of the information signal (in this instance, a multi media signal, in MPEG2 format) is determined, and a set of parameters selected from a predetermined group in dependence upon the determined bit-rate. Within the groups of parameters, different sets correspond to different ranges of bit-rates.

The particular embedding algorithm utilised in this preferred embodiment is the run-merge algorithm described in more detail in WO 02/060182.

The run-merge algorithm embeds a watermark within an MPEG compressed video stream by selectively discarding the smallest quantized DCT coefficients. The discarded coefficients are subsequently merged in the runs of the remaining coefficients. Decision on whether a coefficient is discarded or not is made on the basis of a pre-calculated watermark buffer and the number of already discarded coefficients per 8×8 DCT block.

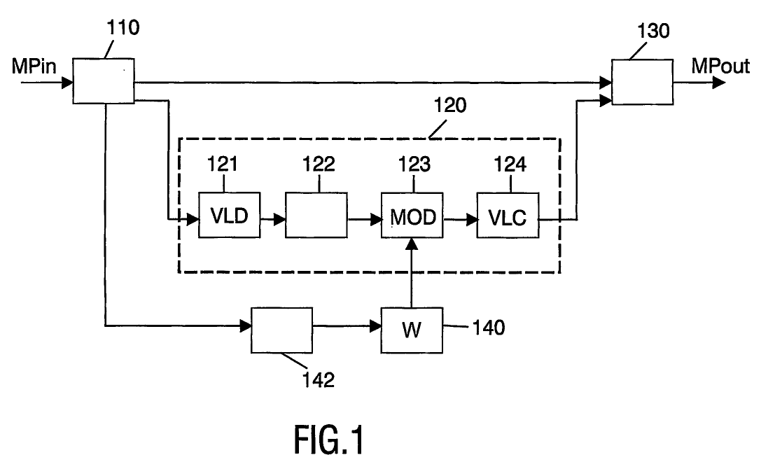

FIG. 1 shows a schematic diagram of an apparatus in accordance with the preferred embodiment. The apparatus comprises a parsing unit 110, a VLC processing unit 120, an output stage 130, a watermark buffer 140 and a bit-rate detector 142. The apparatus is arranged to receive an MPEG elementary video stream MPin which represents a sequence of video image.

An MPEG video image is formed by dividing each picture into blocks of 8×8 pixels. The pixel blocks are in turn represented by respective blocks of 8×8 DCT (Discrete Cosine Transform) coefficients.

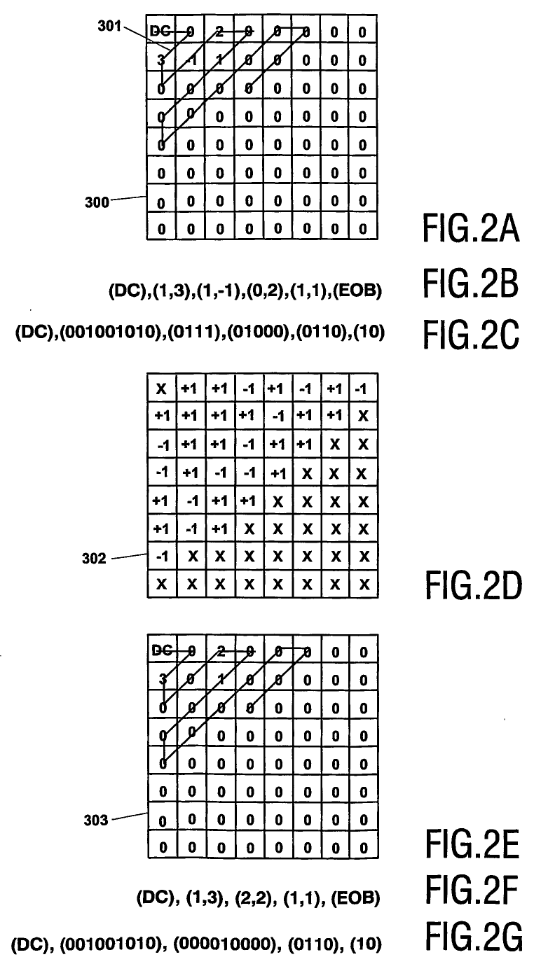

FIG. 2A shows a typical example of a DCT block 300. The upper left transform coefficient of such a DCT block represents the average luminance of the corresponding pixel block, and is commonly referred to as the DC coefficient. The other coefficients represent spatial frequencies and are referred to as AC coefficients. The upper left AC coefficients represent course details of the image, the lower right coefficients represent finer details. The AC coefficients have been quantized. This quantization process causes many AC coefficients of a DCT block to assume the value zero, particularly those representing finer details.

To form the MPEG bit-stream, the coefficients of the DCT block 300 are sequentially scanned a zig zag pattern (shown as 301 in FIG. 2A), and are then variable length encoded. The variable-length encoding scheme is a combination of Huffinan coding and run-length coding. Each run of zero AC coefficients and a subsequent non-zero AC coefficient constitutes a run-pair which is encoded into a single variable-length code word. FIG. 2B shows the run-level pairs of the DCT block 300. FIG. 2C shows the series of variable-length code words (VLCs) representing DCT block 300, as might be received by the apparatus shown in FIG. 1 as signal MPin.

In an MPEG2 elementary video stream, four such DCT luminance blocks and two or more DCT chrominance blocks constitute a macro block, a number of macro blocks constitutes a slice, a number of slices constitutes a picture (field or frame), and a series of pictures constitutes a video sequence. Some pictures are autonomously encoded (I-pictures), other pictures are predicatively encoded with motion compensation (P- and B-pictures). In P- and B- pictures, the DCT coefficients represent differences between pixels of the current picture and pixels of one or more reference pictures, rather than the actual pixels themselves.

The MPEG2 elementary video stream MPin is applied to the parsing unit 110. The parsing unit 110 partially interrupts the MPEG bit-stream, and splits the stream into variable-length code words (VLCs) representing luminance DCT coefficients, and other MPEG codes including codes indicative of the signal bit-rate. The unit also gathers information such as the coordinates of the blocks, the coding type (field or frame), the scan type (zig zag or alternate). The VLCs and associated information are applied to the VLC processing unit 120. The other MPEG codes are directly applied to the output stage 130, with a copy of the bit-rate information being applied to the bit-rate determining unit 142.

In this embodiment, the watermark to be embedded is a pseudo-random noise sequence in the spatial domain. For instance, the watermark can be envisaged as a two dimensional picture image. The spatial pixel values of the basic watermark are transformed to the same representation as the video content in the MPEG stream. In other words, the watermark picture is divided into a block of 8×8 pixels, and the relevant blocks discrete cosine transformed and quantized. It should be noted that the transform and quantizing operation needs to be only done once for any particular watermark. The DCT coefficients thus calculated are stored in the watermark buffer 140.

The watermark buffer 140 is connected to the VLC processing unit 120, in which the actual embedding of the watermark takes place. The VLC processing unit decodes (121) selected variable-length code words representing the video image into run-level pairs, and converts (122) the series of run-level pairs into a two dimensional array of 8×8 DCT coefficients. The watermark is embedded, in modification stage 123, by adding to each video DCT block the spatially corresponding watermark DCT block. This addition is performed in accordance with embedding parameters, which will be described below in more detail.

FIG. 2D shows a typical example of a watermark DCT block 302 corresponding to a portion of a spatial watermark. FIG. 2E shows a watermarked video DCT block 303 obtained by addition of watermarked DCT block 302 to video DCT block 300.

Subsequently, the resulting watermarked DCT block is re-encoded by a variable-length encoder 124. The watermarked VLCs are applied to the output stage 130, which regenerates the MPEG stream by copying the MPEG codes provided by the parsing unit 110, and inserting regenerated VLCs provided by the VLC processing unit 120. Furthermore, the output stage may insert stuffing bits to make the output bit-rate equal to the original video bit-rate.

The manner in which the watermark DCT coefficients are applied to the signal DCT coefficients is controlled by a number of embedding parameters. Such parameters can define rules by which the watermark is applied.

For instance, in the example shown in FIGS. 2A-2E, the watermark coefficients shown in block 302 are only added to the DCT coefficients of the original picture block 300 when the resultant respective value will be equal to zero. In this specific example, only one of the non-zero coefficients (the one with the value −1 in FIG. 2A) is turned into a zero coefficient in block 2E, because the spatially corresponding watermark coefficient in block 302 has the value +1. FIG. 2F shows the run-level pairs of the watermarked DCT block. Note that the former run-level pairs (1, −1) and (0, 2) have been replaced by one run-level pair (2, 2). FIG. 2G shows the corresponding output bit-stream. The run-merge operation thus appears to have altered only one AC DCT coefficient in this example.

Various embedding parameters may be used to control the embedding process, and to implement the strength with which the watermark is applied, and how the watermark is applied.

Table 1 illustrates three different parameter sets for different bit-rates within the MPEG coding standard.

As can be seen, one set of parameters is utilised for the high definition (HD) content at a bit-rate of 10 MB/s, whilst different parameter sets are utilised for respective bit-rates in the ranges 5-8 MB/s and 1-5 MB/s.

The “No. of Changes” value indicates the maximum number of changes allowed to be made to the DCT coefficient attributes within any single 8×8 DCT block.

TABLE 1

| Data Type | HD | D1 | D1 |
|---|---|---|---|
| Bit-Rate | 10 MB/s | 5-8 MB/s | 1-5 MB/s |
| No. of Changes | 63 | 3 | 5 |
| EI | 500 | 50 | 70 |
| EP | 500 | 10 | 25 |
| EB | 500 | 75 | 75 |
| CDR | False | True | True |
| ULQ | False | False | True |
| EI % | 100 | 100 | 25 |
| EP % | 100 | 100 | 25 |
| EB % | 100 | 100 | 25 |

EL, EP, EB represent respectively the energy levels for I-frames, P-frames and B-frames at which energy can be discarded per DCT block based upon the current quantization factors of the DCT block. This takes into account the scaling factor of the DCT blocks and lowers the number of coefficients that can be altered by the watermark.

The value of the CDR (Content Dependent Rate) coefficient determines whether a check is made to determine whether frequency components are regarded as significant within the MPEG stream. For instance, it will be recalled that low frequency components in an 8×8 block, such as block 300, appear in the upper left of the block, with higher frequency components appearing in the lower right of the block. In the example block 300 shown, it will be seen that only a relatively small number of low frequency components exist i.e. the high frequency components would not be regarded as significant to the content of the picture.

The ULQ (Use Linear Quantizer) value determines whether energy calculations are performed according to either a linear quantization scale, or an exponential scale. Such energy calculations are used to determine the watermark energy added to the signal e.g. by scaling the values of the watermark coefficients. This will determine the impact of the resulting watermark upon the observability of the watermark signal, as well as how detectable the watermark is (the accuracy of most watermark detectors is dependent upon the amount of energy within the watermark relative to the energy of the signal within which the watermark is embedded).

Finally, the EI %, EP % and EB % set thresholds on how much percentage energy of any given DCT block can be discarded by the application of the watermark.

By appropriate selection of the different embedding parameters based upon the determined bit-rate, the trade off between the robustness and observability of a watermark within an information signal can be optimised.

It will be appreciated that the above embodiment is provided by way of example only. For instance, whilst a predetermined parameter set has been utilised in the preferred embodiment for each bit-rate (or range of bit-rates) considered, the parameter set could in fact be linked to the bit-rate by a predetermined algorithm.

Equally, whilst the described parameters have in the example given had an effect on the strength with which the watermark is embedded within the information signal, the embedding parameters could in fact be utilised to select an appropriate watermark scheme to apply the watermark to the information signal, and/or to alter the watermark applied to the information signal. In such instances, the bit-rate will thus affect the process by which the watermark can be detected.

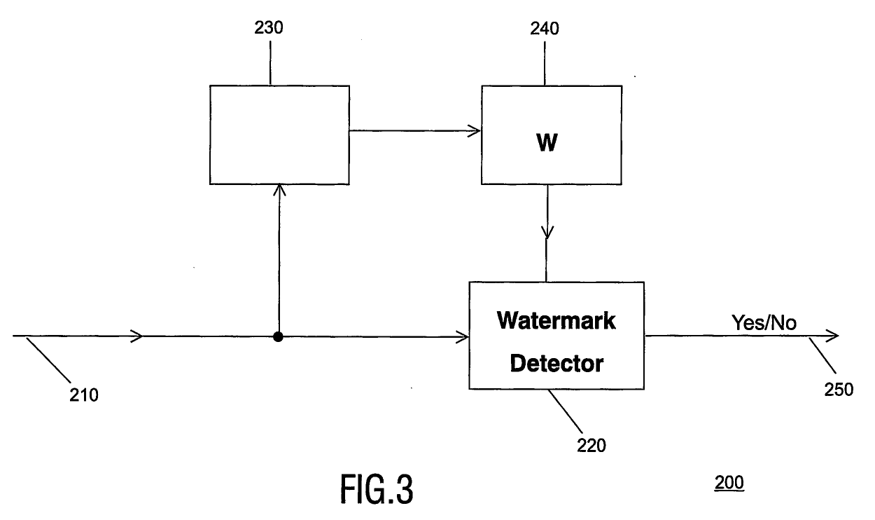

FIG. 3 shows a watermark detector 200 in accordance with an embodiment of the present invention. In this example, it is assumed that the watermark embedding process is altered by a bit-rate dependent parameter such that different detection processes will be required for different bit-rate signals. The watermark detector 200 comprises an input 210 arranged to receive an information signal that may potentially be watermarked. Bit-rate detector 230 determines the bit-rate of the received signal to a predetermined accuracy (such a bit-rate can be determined either by analysing the signal, or by decoding a part of the signal if the bit-rate is encoded within the signal). Information on the bit-rate is then passed to the watermark parameter buffer 240, and utilised to select the appropriate parameters to be used by the watermark detector 220.

The watermark detector 220 receives a copy of the selected watermark parameters, and a copy of the received information signal, and subsequently provides at output 250 an indication on whether the received signal is indeed watermarked. For instance, the presence or absence of the watermark can determine whether copying of the information signal is allowed.

It will be appreciated by the skilled person that various implementations not specifically described will be understood as falling within the scope of the present invention. For instance, whilst only the functionally of the embedding and detecting apparatus has been described, it will be appreciated that the apparatus could be realised as a digital circuit, an analog circuit, a computer program or a combination thereof.

Such computer programs, as well as any watermarked signals generated by the embedding method of the present invention, can be stored on any machine readable medium (e.g. a computer memory, a floppy disk, a compact disc or the equivalent), or can be transmitted along any transmission medium, including both wireless and wireline medium. The term record carrier in the present specification is taken to include both such machine readable medium and such transmission medium.

Within the specification it will be appreciated that the words “comprising” does not exclude other elements or steps, that “a” or “an” does not exclude a plurality, and that a single processor or other unit may fulfil the functions of several means recited in the claims.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of embedding a watermark in an information signal, wherein the watermark embedding process is controlled by at least one embedding parameter, the value of the embedding parameter being dependent upon the bit-rate of the information signal.

2. A method as claimed in claim 1, the method further comprising the step of determining the bit-rate of the information signal.

3. A method as claimed in claim 2, wherein information indicative of the bit-rate is encoded in the information signal, the bit-rate being determined by decoding the information indicative of the bit-rate.

4. A method as claimed in claim 1, wherein the value of the embedding parameter is selected from a predetermined set of values in dependence upon the bit-rate of the information signal.

5. A method as claimed in claim 1, wherein at least one of the robustness of the watermark signal and the observability of the watermark signal is dependent upon said embedding parameter.

6. A method as claimed in claim 1, wherein the value of the embedding parameter determines the watermarking technique utilised to embed the watermark in the information signal.

7. A method as claimed in claim 1, wherein the strength of the watermark is dependent upon the value of the embedding parameter.

8. An apparatus arranged to embed a watermark in an information signal, the apparatus comprising an embedding means arranged to embed a watermark in the information signal utilising an embedding process controlled by at least one embedding parameter, the value of the embedding parameter being dependent upon the bit-rate of the information signal.

9. An apparatus as claimed in claim 8, the apparatus further comprising a bit-rate determining unit arranged to determine the bit rate of the information signal.

10. A watermarked information signal, wherein the original information signal has been watermarked by a watermarking process controlled by at least one embedding parameter, the value of the embedding parameter having been dependent upon the bit-rate of the information signal.

11. A record carrier comprising a watermarked information signal as claimed in claim 10.

12. A method of detecting a watermark in an information signal, the method comprising analysing an information signal that may potentially comprise a watermark, so as to detect the watermark, the analysing process being dependent upon the bit-rate of the information signal.

13. An apparatus for the detection of a watermark in an information signal, the apparatus comprising analysing means arranged to analyse an information signal that may potentially comprise a watermark, so as to detect the watermark, the operation of the analysing means being dependent upon the bit-rate of the information signal.

14. A computer program arranged to perform at least one of the method of claim 1 and method of claim 12.

15. A record carrier comprising a computer program as claimed in claim 14.

16. A method of making available for downloading a computer program as claimed in claim 14.
